(19) United States
(12) Patent Application Publication
(10) Pub. No.: US 2012/0268603 A1
(43) Pub. Date: Oct. 25, 2012

(54) VIDEO SURVEILLANCE SYSTEM

(76) Inventor: Peter Sarna, II, Clayton, CA (US)

(21) Appl. No.: 13/090,958

(22) Filed: Apr. 20, 2011

(51) Int. Cl. H04N 7/18

(52) U.S. Cl. 348/152; 348/E07.085

(57) ABSTRACT

A system and method are disclosed. The system includes an user security portal operable to access live video feeds of areas of interest taken by a video camera. The user security portal includes an user interface operable to display an evaluation cycle. The evaluation cycle includes a security display window which displays the live video feeds of the monitored areas. In addition, the security display window includes evaluation parameters associated with the monitored areas and contingency action parameters which list action items to be taken in the event of a security breach of at least one evaluation parameters.

### FIELD OF INVENTION

This invention relates generally to video surveillance systems, and more specifically to a system and method for providing security personnel with evaluation and contingency action parameters to aid them when monitoring a given area.

### BACKGROUND OF THE INVENTION

Video surveillance systems have been around for many years. In particular, the video surveillance systems presently known typically comprise a series of video cameras positioned inside and around an area of interest. For example, video cameras may be positioned at entrances to buildings, in parking lots, and in common areas of work places. Typically, live video feeds from these cameras are streamed to workstations in a control room and subsequently displayed onto monitors accessible to security personnel.

In conventional video surveillance systems, security personnel are required to monitor the output displays of live video feeds displayed from various video monitors. However, due to the few number of security personnel relative to the number of video monitors, conventional video surveillance systems limit the amount of attention each security personnel can give to monitoring each video feed.

Furthermore, in conventional video surveillance systems, each monitored area typically has unique security protocols and procedures. For example, the entrance gate to a parking lot may require a different set of security procedures than that of a corridor inside a building. As such, security personnel evaluate the live video feeds according to pre-determined security procedures. However, conventional video surveillance systems do not have a mechanism for ensuring that each security personnel considers pre-determined security procedures for each monitored area or that each security personnel has the requisite alertness while monitoring the video feeds.

Accordingly, there is a need for a video surveillance system which enables security personnel to provide enough attention to each live video feed, ensure that security personnel considers pre-determined security procedures for each monitored area, and determine whether security personnel has the requisite alertness to monitor the video feeds. The present invention addresses these needs.

### SUMMARY OF THE INVENTION

A system and method are disclosed. The system includes an user security portal operable to access live video feeds of areas of interest taken by a video camera. The user security portal includes an user interface operable to display an evaluation cycle. The evaluation cycle includes a security display window which displays the live video feeds of the monitored areas. In addition, the security display window includes evaluation parameters associated with the monitored areas and contingency action parameters which list action items to be taken in the event of a security breach of at least one evaluation parameters.

### BRIEF DESCRIPTION OF THE DRAWINGS

FIG. 1 is an illustration of a control room with security personnel monitoring video surveillance monitors.

FIG. 2 is an illustration of several hardware components of a system in accordance with the present invention.

FIG. 3 is an illustration of a security display window in accordance with a system and method of the present invention.

FIG. 4 is an illustration of a security display window which shows evaluation parameters in accordance with a system and method of the present invention.

FIG. 5 is an illustration of a security display window which shows contingency action parameters in accordance with a system and method of the present invention.

FIG. 6 is an illustration of a security display window in the event of an evaluation test in accordance with a system and method of the present invention.

FIG. 7 is an illustration of a security display window which displays an error message in accordance with a system and method of the present invention.

FIG. 8 is an illustration of an exemplary flowchart of a course of action taken by security personnel while utilizing a system and method of the present invention.

FIG. 9A is an illustration of a system administrator screen for setting evaluation parameters when creating a new evaluation cycle in accordance with a system and method of the present invention.

FIG. 9B is an illustration of a system administrator screen for setting the video camera selections when creating a new evaluation cycle in accordance with a system and method of the present invention.

FIG. 9C is an illustration of a system administrator screen for setting the oversight and notifications for a new evaluation cycle in accordance with a system and method of the present invention.

FIG. 10A is an illustration of a system administrator screen which displays evaluation parameters associated with an area displayed during an evaluation cycle in accordance with a system and method of the present invention.

FIG. 10B is an illustration of a system administrator screen which displays contingency action parameters associated with an area displayed during an evaluation cycle in accordance with a system and method of the present invention.

FIG. 10C is an illustration of a system administrator screen which displays notifications information associated with an area during an evaluation cycle in accordance with a system and method of the present invention.

FIG. 10D is an illustration of a system administrator screen which displays a test video feed for an evaluation cycle in accordance with a system and method of the present invention.

FIG. 11 is an illustration of a system administrator screen for setting evaluation cycle parameters when creating an evaluation cycle for a special event in accordance with a system and method of the present invention.

FIG. 12A is an illustration of a security display which displays multiple live video feeds in accordance with a system and method of the present invention.

FIG. 12B is an illustration of a security display window which displays a selected live video feed from a plurality of video feeds in accordance with a system and method of the present invention.

FIG. 12C is an illustration of a security display window which displays a selected live video feed and associated evaluation parameters in accordance with a system and method of the present invention.

FIG. 13 includes illustrations of mobile phones to which event alerts, test feed failure alerts, and evaluation cycle timeout alerts are sent in accordance with a system and method of the present invention.

FIG. 14 is an exemplary flowchart for users of a video surveillance system in accordance with a system and method of the present invention.

### DETAILED DESCRIPTION

This invention relates generally to video surveillance systems, and more specifically to a system and method for providing security personnel with evaluation and contingency action parameters to aid them in monitoring a given area. The following description is presented to enable one having ordinary skill in the art to make and use the embodiment and is provided in the context of a patent application. The generic principles and features described herein will be apparent to those skilled in the art. Thus, the present embodiment is not intended to be limited to the embodiments shown, but is to be accorded the widest scope consistent with the principles and features described herein.

A system and method in accordance with the present invention may be utilized to enable security personnel to provide enough attention to each live video feed within a video surveillance system. In addition, a system and method in accordance with the present invention may be used to ensure that each security personnel considers pre-determined security parameters when determining whether a security breach has occurred. Furthermore, a system and method in accordance with the present invention may be utilized to determine whether each security personnel has the requisite alertness to monitor the live video feeds within the video surveillance system. It is to be understood that authorized personnel may include security personnel, system administrators, and/or subscribing supervisors to a notification system, in accordance with a system and method of the present invention.

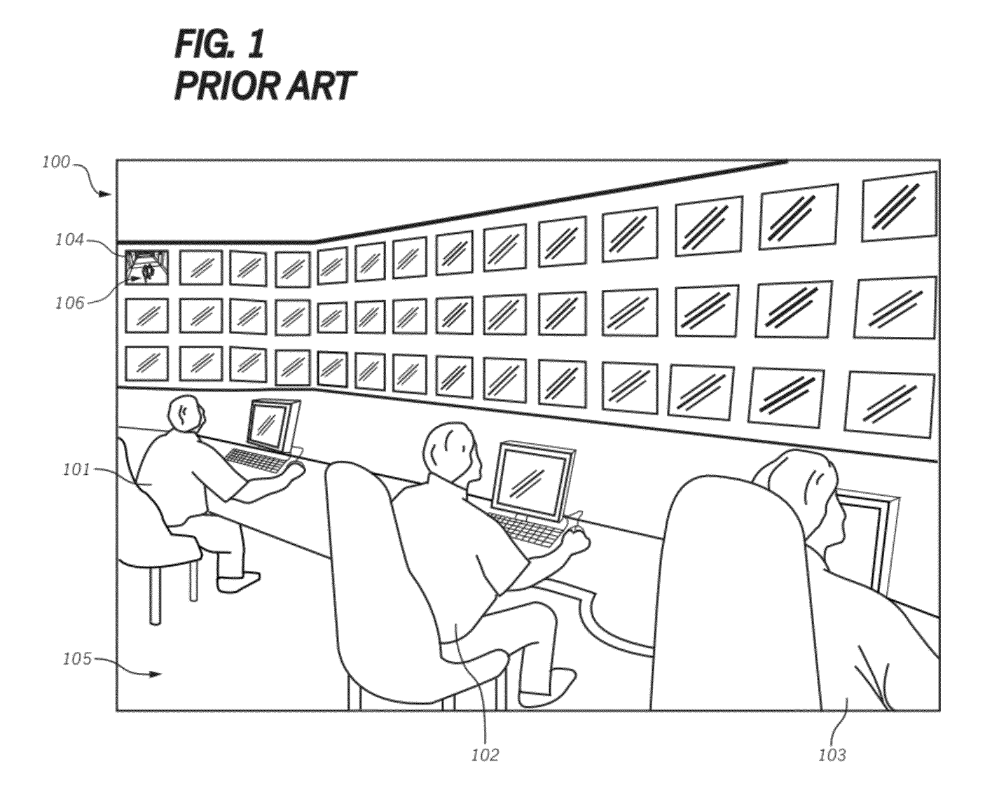

FIG. 1 is an illustration of a video security system 100 consistent with the prior art. As shown, three security personnel 101, 102, 103 are within control room 105, which has a plurality of video monitors 104 therein. Each video monitor 104 displays a live video feed 106 (exemplary live video feed for monitors 104) of a monitored area.

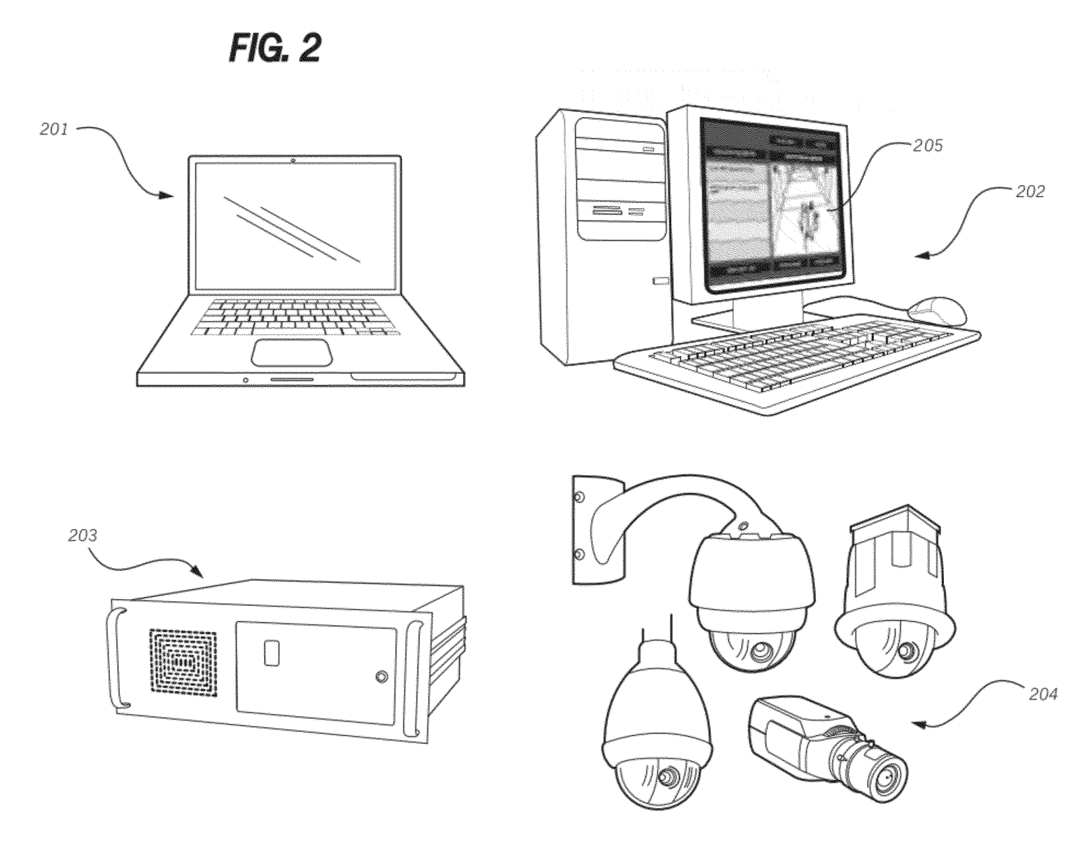

FIG. 2 is an illustration of hardware commonly used for video surveillance systems in accordance with a system and method of the present invention. As shown, FIG. 2 illustrates system administration workstation 201, user security portal 202, digital video recorder (DVR) 203, and video cameras 204.

As shown, system administration workstation 201 is a laptop. However, system administration workstation 201 may be any of a personal computer, laptop, netbook, and/or any other computer system and this would be in the spirit and scope of the present invention. System administration workstation 201 allows a system administrator and other authorized personnel access to a system in accordance with the present invention. In an embodiment, a password is required for a user to log in to system administration workstation 201.

In an embodiment, system administration workstation 201 allows authorized personnel the ability to create new evaluation cycles, edit pre-existing evaluation cycles, set notifications, etc. In addition, authorized personnel may utilize system administration workstation 201 to monitor the course of an evaluation cycle ran by security personnel in order to gauge security personnel alertness, decision-making ability, execution of security protocol, and rate through the evaluation cycle. Accordingly, system administration workstation 201 has access to all information available to the user security portal 202.

FIG. 2 further shows that the user security portal 202 is a personal computer. However, the user security portal 202 may be any of a personal computer, laptop, netbook, and/or any other computer system and this would be in the spirit and scope of the present invention. In an embodiment, the user security portal 202 is accessible to security personnel. For example, security personnel may utilize the user security portal 202 to run and display an evaluation cycle. In an embodiment, security personnel may run an evaluation cycle by activating a security surveillance session. An evaluation cycle may include a series of live video feeds among other attributes. Moreover, an evaluation cycle may include evaluation parameters, contingency parameters, and test feeds displayed within a security display window.

In an embodiment, security personnel run an evaluation cycle and view the displayed content of the evaluation cycle via a user interface 205. In addition, the user interface 205 may enable the security personnel to make a selection, provide an input, and/or run a command in response to a prompt provided to the security personnel during the evaluation cycle. For example, during an evaluation cycle, the user interface 205 may enable the security personnel to make a selection as to whether a displayed live video feed is within limits or whether additional action is needed based on the security personnel's judgment, knowledge, discretion, and the displayed evaluation parameters.

Furthermore, a system and method in accordance with the present invention may include a digital video recorder 203, as illustrated in FIG. 2. The digital video recorder 203 may be utilized to record live video feeds taken by video cameras 204. Upon request by authorized personnel, pre-recorded video feeds obtained during the run of past evaluation cycles may be accessed, replayed, converted to a test feed, or manipulated in any manner desired by the requester of the recorded video feed.

In an embodiment, each live video feed of an evaluation cycle, in their entirety, are recorded and stored in the digital video recorder 203. However, a system administrator or other authorized personnel has the ability to set a recording schedule, in addition to set which portion of the evaluation cycle is to be recorded, according to a need of an organization and storage bandwidth of the digital video recorder 203. Furthermore, the authorized personnel may set the duration to which the recorded videos are to remain in the digital video recorder 203 before the stored recorded videos are purged.

One having ordinary skill in the art may appreciate that digital video recorder 203 has conventional video control functionality such as, but not limited to, play, pause, stop, rewind, fast forward, playback, and this is in the spirit and scope of the present invention. In an embodiment, system administration workstation 201 may be used to control the setting and functionality of digital video recorder 203.

Furthermore, in an embodiment in accordance with the present invention, the digital video recorder 203 may be stored in a control room of an organization. For example, one or more digital video recorders 203 may be stored in a control room within a security suite of a company's corporate office, each coupled to a set of video cameras 204.

In yet another embodiment, the digital video recorder 203 may be a network video recorder (network DVR). In an embodiment, a network DVR 203 captures digital video streams and images over a network from remote IP video cameras and/or video servers and records the captured digital video streams onto a hard disk in digital format. The network DVR 203 may be stored in a central office.

Furthermore, a system and method in accordance with the present invention may include video cameras 204. Video cameras 204 may be any or a combination of a fixed IP camera, fixed dome camera, PTZ camera, network dome camera, and any other video camera which adequately capture and transfer video streams. It is to be understood that the present invention is not limited to network or IP video cameras.

In an embodiment, video cameras 204 are network video cameras, which each includes a built-in web server, an IP address, and recording circuitry. In an embodiment, the built-in recording functionality of the network video cameras 204 captures video using scheduled or triggered recording then uploads the video to an FTP, server, video server, or network video recorder. For example, network video cameras 204 may capture live video feeds of a given area and subsequently transfer the captured video feeds to network DVR 203.

In addition, system administration workstation 201 and user security portal 202 maintain the IP address of each network video camera 204 according to an embodiment of the present invention. As such, system administration workstation 201 and user security portal 202 may display live video feeds from the network video cameras 204 during the creation and execution of evaluation cycles.

It should be understood that the present invention is not limited to the hardware illustrated in FIG. 2. Particularly, embodiments of the present invention may include all or less than the hardware illustrated in FIG. 2 and this will be in the spirit and scope of the present invention. In addition, system administrators, subscribing supervisors, and other authorized personnel may each be a single individual or may be multiple individuals. For example, there may be a team of security personnel, designated system administrators, and subscribing supervisors. In addition, security personnel may include a team of security guards.

Furthermore, individual security personnel may serve multiple roles. For example, an individual may log into the user security portal 202 as security personnel but may have system administrative privileges. Moreover, this individual may be a manager within an organization which may qualify him/her as a subscribing supervisor to receive notifications and alerts. One having ordinary skill in the art can appreciate that there may be many individuals in an organization designated as security personnel, system administrators, and/or subscribing supervisors and this will be in the spirit and scope of the present invention.

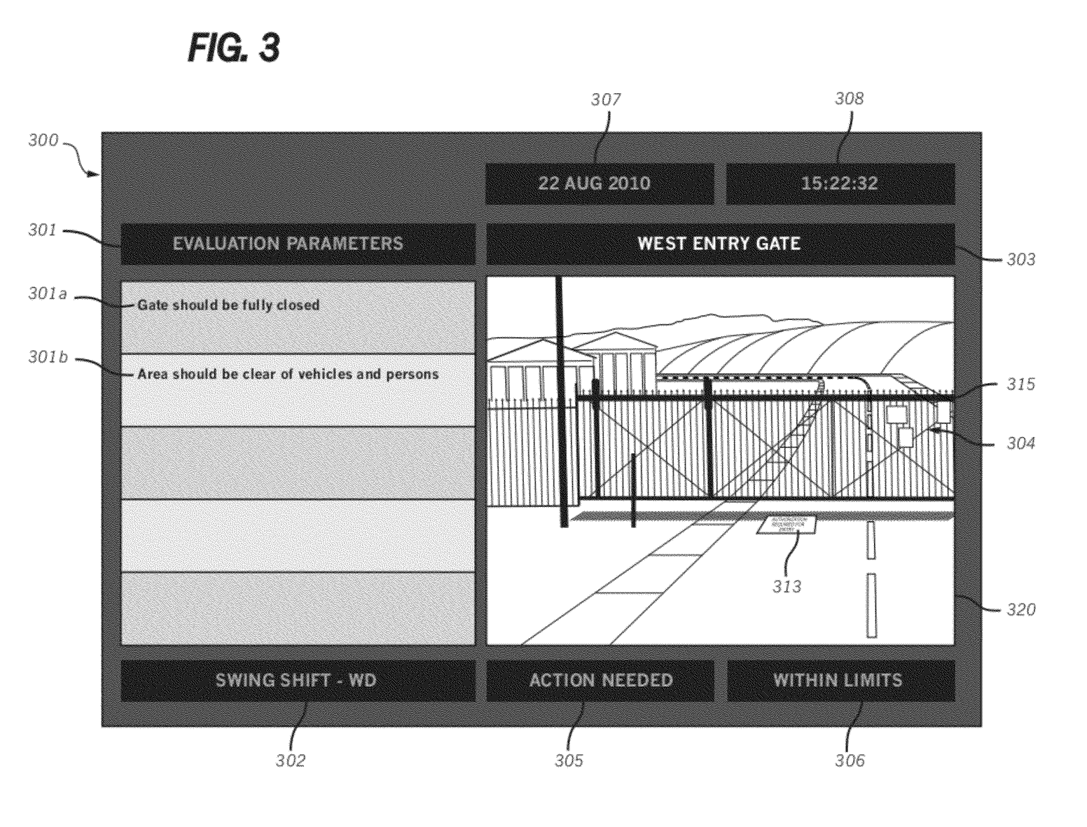

FIG. 3 is an illustration of a security display window 300 in accordance with a system and method of the present invention. As illustrated, security display window 300 includes live video feed 320, video camera location name field 303, parameter name field 301, evaluation test parameters 301a and 301b, user selection prompts 305, 306, shift field 302, and date and time fields 307, 308. It is to be understood that a security display window of the present invention may include all, more, or less of the aforementioned features in security display window 300 and this will be within the spirit and scope of the present invention.

The security display window 300 displays live video feed 320 of the West Entry Gate as indicated by video camera location name field 303. As shown, live video feed 320 illustrates a closed gate 315 that is clear of vehicles and persons. In an embodiment, security personnel evaluate live video feed 320 according to the evaluation parameters 301a, 301b, in addition to the security personnel's judgment, knowledge, and discretion.

As illustrated, evaluation parameter 301a provides that gate 315 should be fully closed and evaluation parameter 301b states that area 304 should be clear of vehicles and persons. As such, the evaluation parameters 301a, 301b provide a base level of continuity with regards to how security personnel evaluate live video feed 320 for security breaches.

For example, although live video feed 320 shows that gate 315 is fully closed and area 304 is clear of vehicles and persons, the security personnel should also take notice that an obstruction 313 is in front of gate 315. Upon inspection of obstruction 313, the security personnel should utilize their judgment, knowledge, and discretion to select user selection prompt 305 to indicate that action is needed despite the fact that the area 304 around gate 315 is technically in compliance with evaluation parameters 301a and 301b.

Accordingly, a system and method in accordance with the present invention is operable to identify violations, infractions, derelictions, and security breaches according to pre-defined evaluation parameters and security personnel's judgment, knowledge, and discretion. In an embodiment of the present invention, violations, infractions, derelictions, and security breaches may all be generally referred to as a breach.

In addition, shift field 302 and date and time fields 307, 308 are displayed within security display window 300, as illustrated in FIG. 3. In an embodiment, the shift, date, and time data displayed in the aforementioned fields may provide essential information for security personnel when making a determination as to which user selection prompt to choose. For example, if security personnel have knowledge that janitorial workers clean in front of the West Entry Gate daily at 7:00 pm, the security personnel may utilize their judgment, knowledge, and discretion to disregard the violation and select user selection prompt 306 to evaluate the next live video feed. As such, a system and method in accordance with the present invention allow security personnel to utilize their knowledge, judgment, and discretion when determining whether a security breach has occurred.

Moreover, the shift, date, and time data may be useful for system administrators, subscribing supervisors, and other authorized users to aid in determining the causes of security compliance failures, breaches in security, and for assessing security personnel performance. In an embodiment, the shift, date, and time data are captured and stored in memory such that when a live video feed is replayed said aforementioned data is retrievable and displayable to the requesting personnel. In yet another embodiment, the shift, date, and time data is stored in the same storage device as the recorded live video feeds.

As previously stated, an evaluation cycle displays a sequence of live video feeds to security personnel. In the embodiment, an evaluation cycle presents the feeds to security personnel consecutively. Once security personnel indicate that an area shown in a displayed live video feed is in compliance, security personnel can proceed to evaluate the next feed by selecting the appropriate user selection prompt. In an embodiment, if security personnel fail to select an user selection prompt to indicate whether the area is in compliance, the evaluation cycle will proceed to display the next live video feed at a predetermined time according to a default setting.

For example, authorized personnel such as a system administrator can set a default setting such that the evaluation cycle proceeds to a next live video feed in the event that security personnel fails to indicate, via user selection prompts, within five seconds whether an area is in compliance. As such, a default setting can allow security personnel the ability to monitor a series of live video feeds without actively engaging the user selection prompts until the security personnel determines that an area is in non-compliance. It is to be understood that a system administrator can set any time for the evaluation cycle to proceed in displaying the next live video feed such that security personnel has adequate time to evaluate each feed and this would be in the spirit and scope of the present invention.

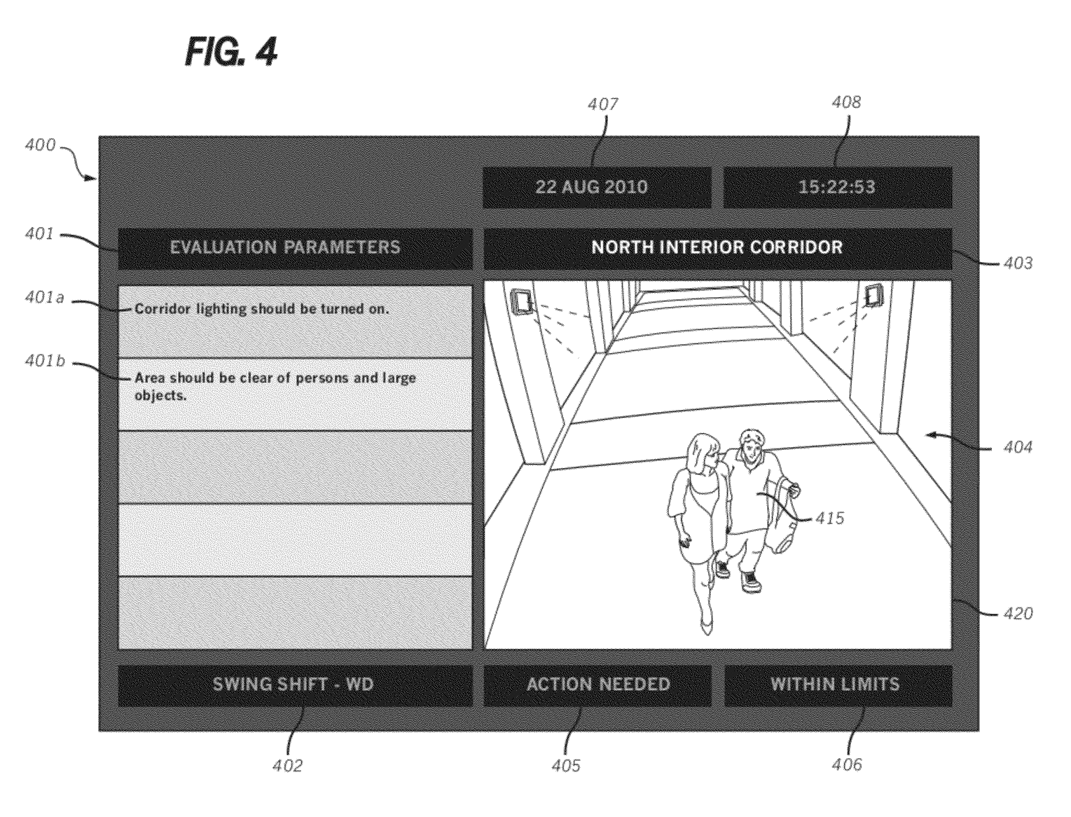

FIG. 4 is an illustration of a security display window 400. As illustrated, security display window 400 includes live video feed 420, video camera location name field 403, parameters name field 401, evaluation parameters 401a and 401b, user selection prompts 405, 406, shift field 402, and date and time fields 407, 408. As shown, the security display window 400 displays live video feed 420 of the North Interior Corridor 404. As shown, a party of two 415 are shown walking through the North Interior Corridor 404.

Accordingly, security personnel may evaluate the details of the live video feed 420 in accordance to the evaluation parameters 401a, 401b, in addition to the judgment, knowledge, and discretion of the security personnel. As such, security personnel may choose one of user selection prompts 405, 406 based on their response to viewing the live video feed 420.

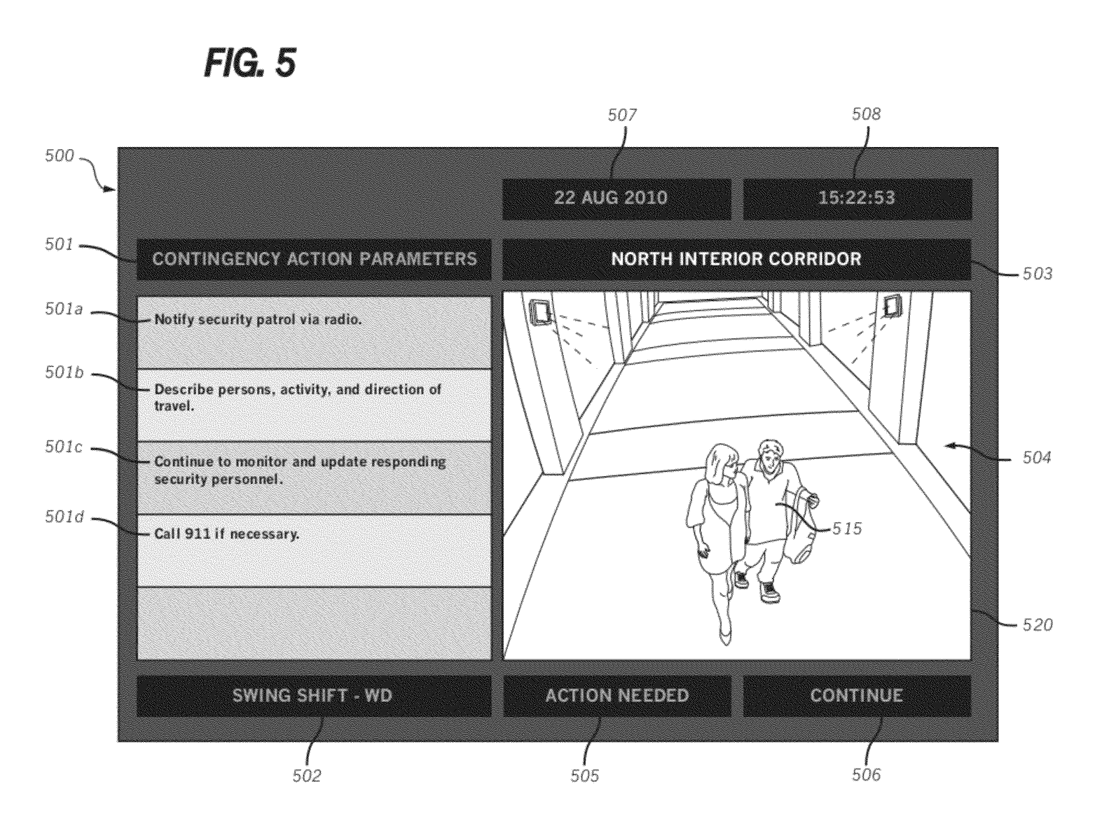

As illustrated in FIG. 4, the presence of party of two 415 in the corridor 404 clearly violate the evaluation parameters since evaluation parameter 401b informs that the corridor 404 should be clear of persons and large objects. As such, security personnel may utilize their judgment, knowledge of the area, and discretion when determining which user selection prompt to select. In the event that security personnel select user selection prompt 405, security display window 500 is displayed, as illustrated in FIG. 5.

FIG. 5 is an illustration of a security display window 500. As illustrated, security display window 500 includes live video feed 520, video camera location name field 503, parameters name field 501, evaluation parameters 501a-501d, user selection prompts 505, 506, shift field 502, and date and time fields 507, 508.

As shown, security display window 500 is an illustration of a set of contingency action parameters. In an embodiment, security display window 500 incorporates all of the components displayed in the preceding security display window 400 with the exception of evaluation parameters 401a, 401b. However, it is to be understood that security display window 500 may incorporate more or less attributes and this would be in the spirit and scope of the present invention.

According to contingency action parameters 501a-510d, security personnel are instructed to notify security patrol via radio (501a), describe persons, activity, and direction of travel (501b) in the corridor 504, monitor and update responding security personnel (501c), and call emergency (911) if necessary (501d). As such, contingency action parameters 501a-501d provide a base level of continuity with regards to how security personnel within an organization should respond to security breaches. However, in addition to utilizing the contingency action parameters 501a-501d, security personnel may use their judgment, knowledge, and discretion. Accordingly, a system and method in accordance with the present invention is operable to address security breaches according to pre-defined contingency action parameters, in addition to utilizing security personnel's judgment, knowledge, and discretion.

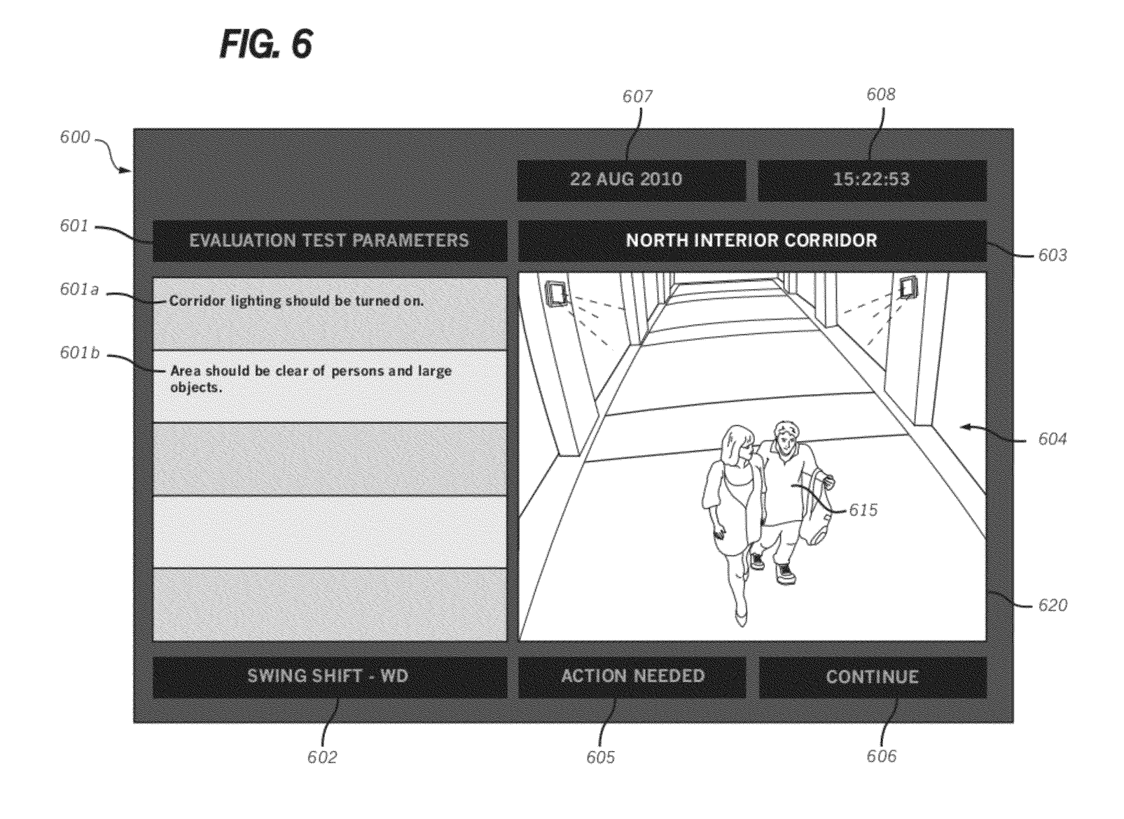

During an evaluation cycle, a test feed may be interjected to test security personnel's attentiveness. For example, FIG. 6 is an illustration of a security display window 600 in the event of an evaluation test, in accordance with a system and method of the present invention. As shown, security display window 600 resembles security display windows 300, 400, and 500. However, “Evaluation Test” is shown in the parameter name field 601. It should be appreciated that security display windows 300, 400, 500, and 600 may or may not resemble each other and this would be in the spirit and scope of the present invention.

As illustrated, security display window 600 includes test feed 620, video camera location name field 603, parameter name field 601, evaluation test parameters 601a and 601b, user selection prompts 605 and 606, shift field 602, and date and time fields 607 and 608. It is to be understood that a security display window of the present invention may include all, more, or less of the aforementioned features in the same position or different positions of the display window and this would also be within the spirit and scope of the present invention.

In an embodiment, an evaluation test may be used to gauge security personnel's alertness, decision-making ability, and execution of security protocol and procedures. For example, test feed 620 illustrates that a party of two 615 are in the North Interior Corridor 604 during the swing shift, which clearly violates evaluation test parameter 601b that the area should be clear of persons and large objects. Accordingly, security personnel should utilize evaluation test parameters, in addition to security personnel's judgment, knowledge, and discretion in making a decision as to whether a security breach has occurred within the North Interior Corridor 604.

If security personnel decides that the presence of the party of two 615 in the North Interior Corridor is in violation of security protocol and the security personnel has no justifiable reason or information to overlook or disregard the breach, the security personnel should select user selection prompt 605 to respond according to the list of contingency action parameters.

Alternatively, if the security personnel selects user selection prompt 606 as an indication that no breach has occurred, a TEST ERROR message will be displayed and a notification may be sent to subscribing supervisors and/or other third parties. It should be appreciated that the security personnel's selection does not necessarily determine that the security personnel made an improper decision or lacks the requisite level of alertness. In an embodiment, security personnel are given some discretion in making a determination to whether a security breach has occurred. However, security personnel should have reason to justify their decision to disregard evaluation test parameters 601a and 601b. In an embodiment, regardless of the security personnel's decision to disregard the evaluation parameters, subscribing supervisors and other authorized third parties should be made aware of such decision by security personnel.

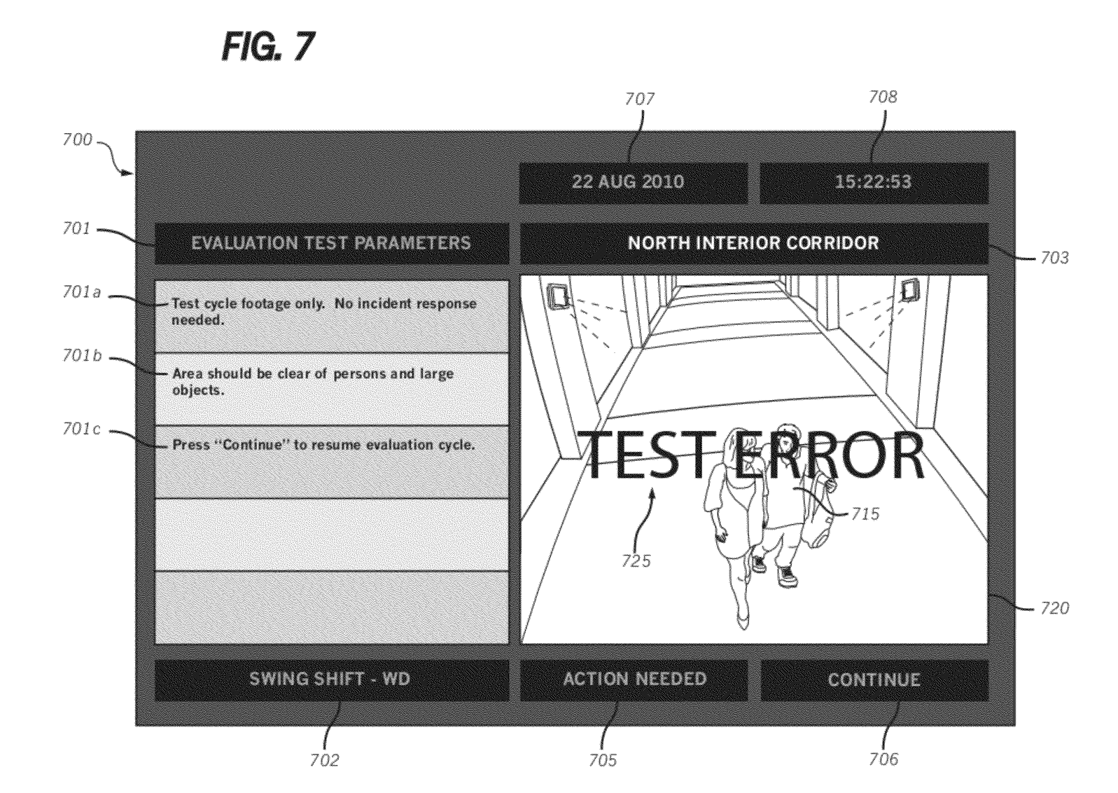

FIG. 7 is an illustration of a security display window 700 that is displayed after security personnel selects user selection prompt 606 (from FIG. 6) in response to an evaluation test. As shown, security display window 700 includes test feed 720, video camera location name field 703, parameter name field 701, evaluation test parameters 701a and 701b, user selection prompts 705 and 706, shift field 702, and date and time fields 707 and 708.

As illustrated, a test error message 725 is displayed upon the image of the party of two 715. As such, an evaluation cycle may be set up or configured as a default setting, such that in the event that the security personnel disregards the manufactured breach by providing an indication to evaluate the next live video feed during an evaluation test, an error message will be displayed.

For example, referring to both FIGS. 6 and 7, if the security personnel selects user selection prompt 606, a test error message 725 is displayed. After security personnel are made aware of the test error message 725, the security personnel are prompted to select user selection prompt 706 to resume the evaluation cycle, as prompted by user selection prompt 701c.

It should be understood that an evaluation cycle may or may not be configured such that the default setting causes an error message to be displayed in the event that the security personnel indicates that no security breach has occurred. However, in an embodiment, a notification is sent to subscribing supervisors and other assigned third parties in the event that security personnel indicates that no security breach has occurred, regardless of whether an error message is displayed.

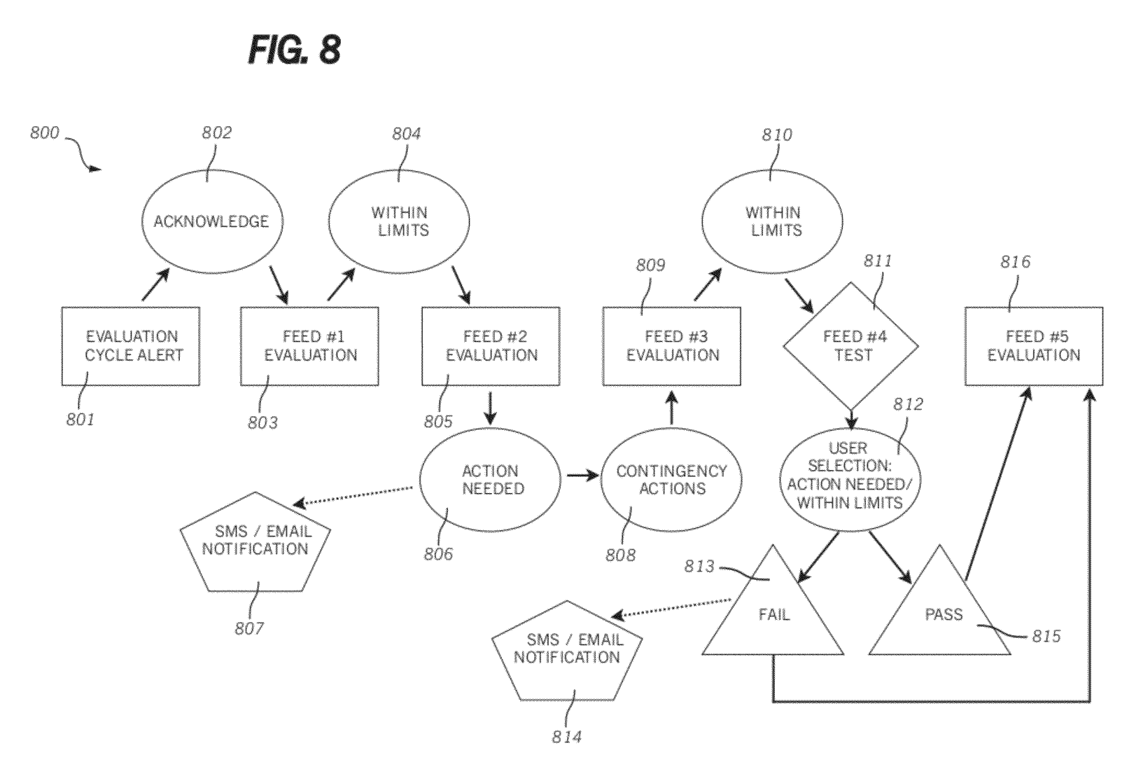

FIG. 8 is an illustration of an exemplary flowchart 800 of a course of action taken by security personnel while utilizing a system and method in accordance with the present invention. As shown, during the course of running an evaluation cycle an evaluation cycle alert was issued and acknowledged by security personnel (blocks 801 and 802) after security personnel activated a security surveillance session. Afterwards, security personnel were presented with video feed #1 for evaluation of security breaches (block 803). Next, security personnel indicated that the conditions presented in video feed #1 were within limits (block 804) and continued to evaluate feed #2 (block 805).

As illustrated by block 806, the security personnel indicated that further action was needed based on the security personnel's assessment of video feed #2. Accordingly, a notification, in the form of a short message servicing (SMS) message and/or an email, was sent to a subscribing supervisor or other assigned parties (block 807). It should be appreciated that the notifications are not limited to SMS and email and that any messaging mode or format which is capable of delivery to a remote party would be in the spirit and scope of the present invention. After security personnel indicated that action was needed based upon their assessment of video feed #2, a set of contingency action parameters were displayed (block 808), which security personnel utilized in addition to their judgment, knowledge, and discretion to address the security breach. Next, security personnel were presented with video feed #3 for evaluation, as indicated by block 809, which was within limits (block 810).

Security personnel proceeded to evaluate video feed #4 which was an evaluation test (block 811). As indicated by block 812, security personnel selected whether the conditions presented by test feed #4 were within limits or if action needed to be taken. If the evaluation cycle was set up such that a default setting caused an error message to display in the event security personnel indicated that no breach had occurred, security personnel's indication that video feed #4 was within limits would have been treated as a FAIL (block 813) and a notification would have been sent out (block 814). Alternatively, if security personnel indicated that the condition within video feed #4 were not within limits and that action was needed, such selection would have been treated as passing (block 815) and no notification would have been issued, sent, or dispatched to subscribing supervisors or other assigned third parties. Finally, security personnel proceeded to video feed #5 for evaluation (block 816) and continued evaluating the ensuing video feeds as the evaluation cycle presented them.

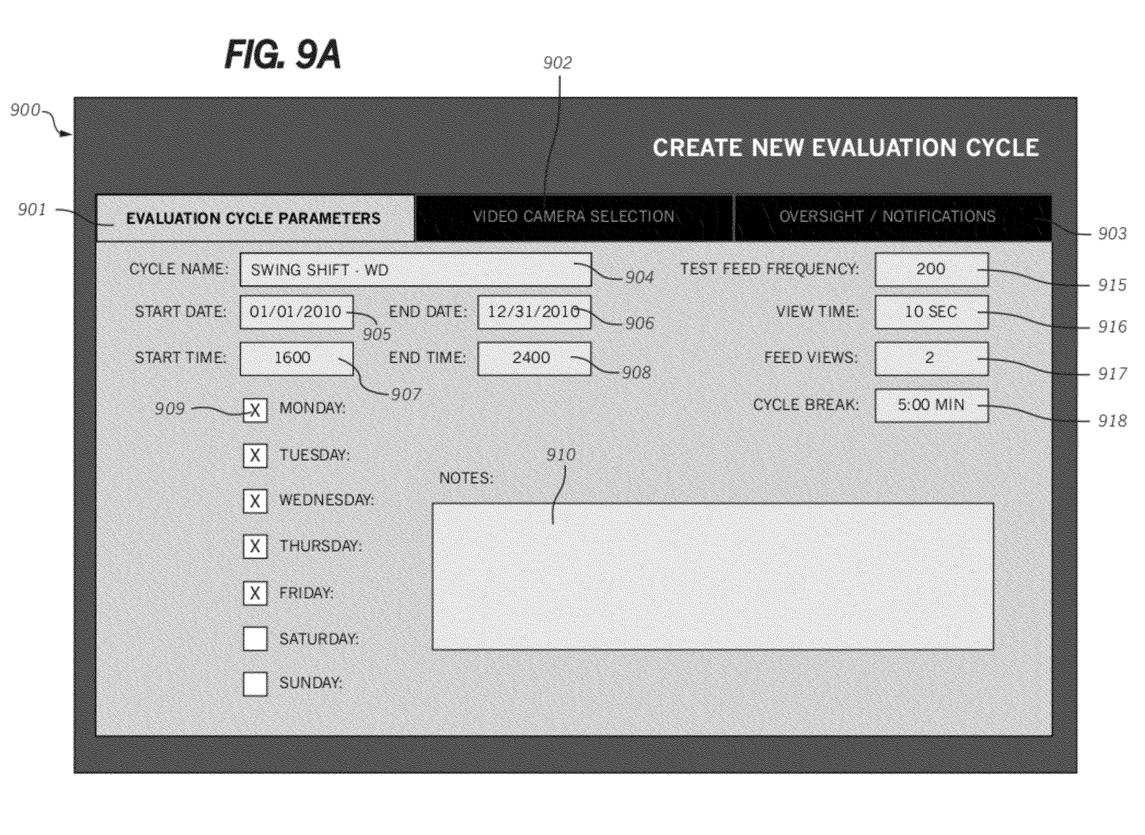

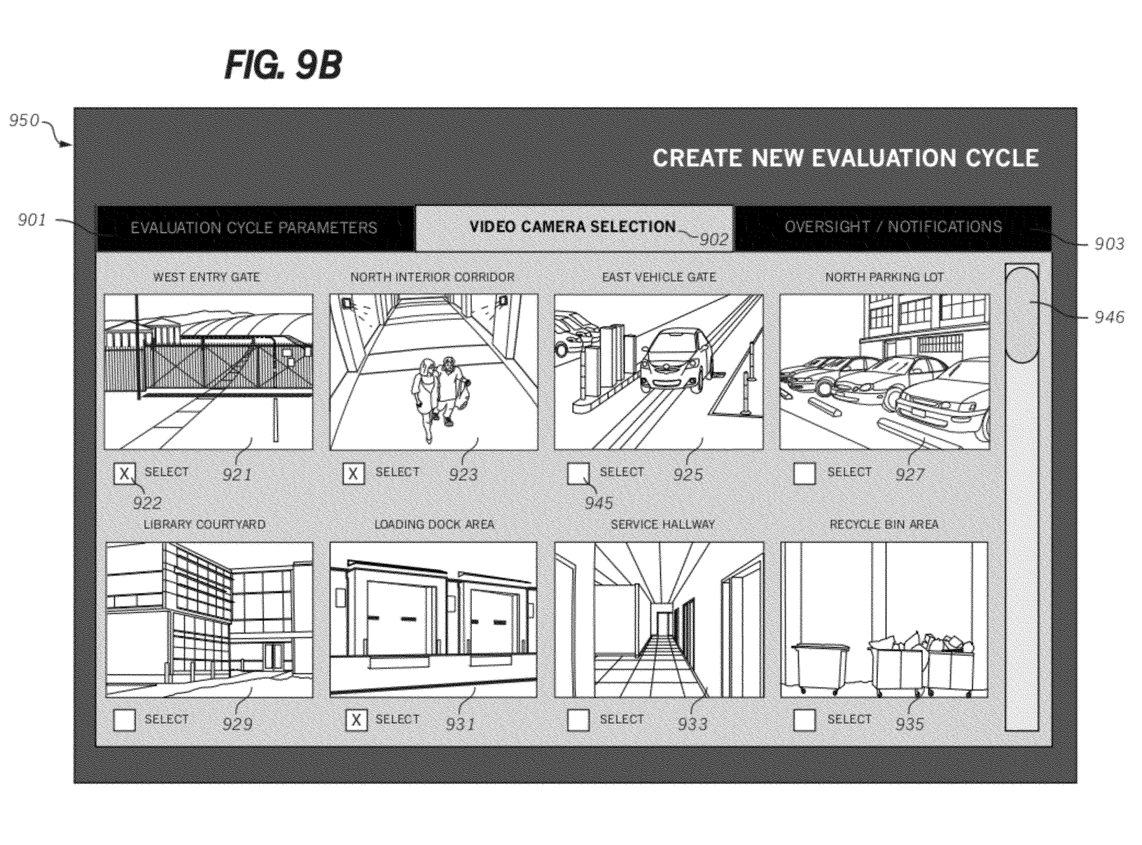

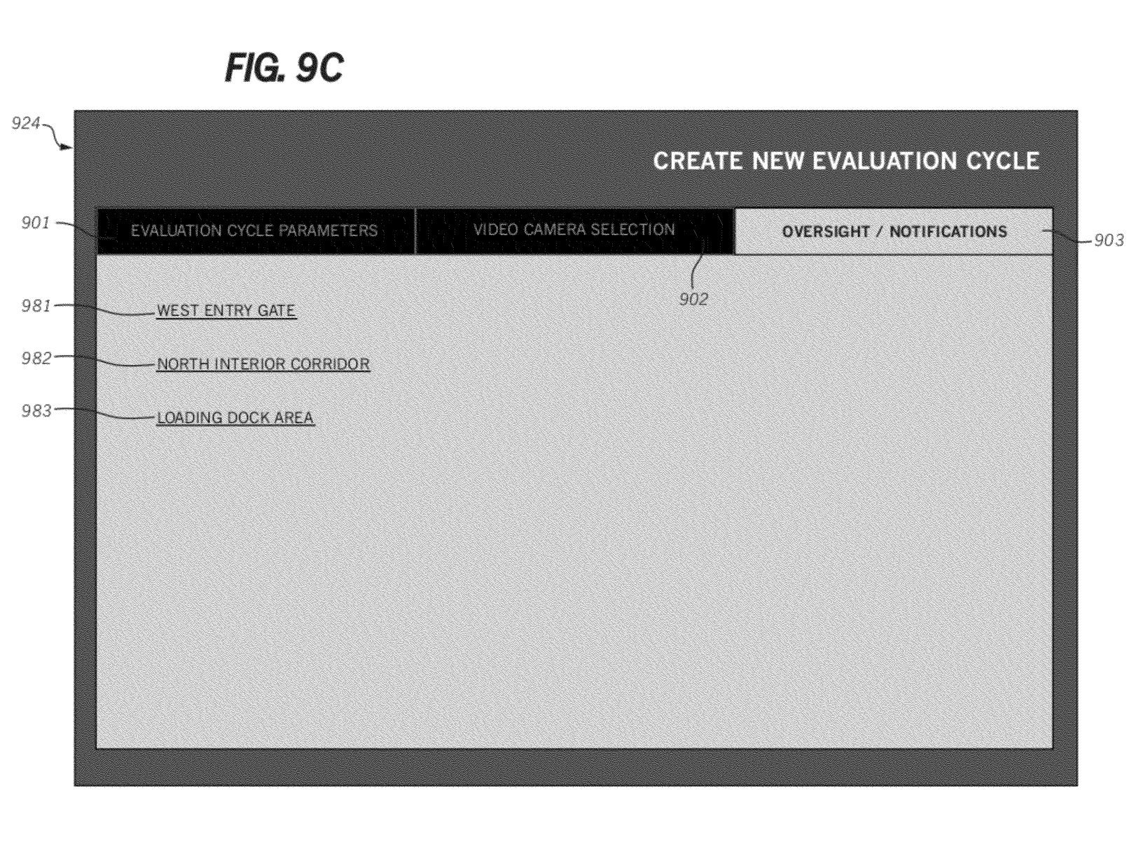

Next, FIG. 9A is an illustration of a system administrator screen 900 for setting evaluation cycle parameters when creating a new evaluation cycle. As illustrated, system administrator screen 900 includes three selectable panes—evaluation cycle parameters pane 901, video camera selection pane 902, and oversight/notifications pane 903. In an embodiment, the system administrator or authorized personnel may set up or configure the evaluation cycle parameters prior to configuring the video camera selections and oversight/notifications parameters on each respective pane. As such, according to the embodiment, the camera selection and oversight/notification parameters are set in relation to the evaluation cycle parameters. In yet another embodiment, the system administrator or authorized personnel may configure the video camera selection parameters prior to setting up the oversight/notification parameters.

An evaluation cycle may be created to run, initiate, or engage during a specified period. For example, an user may activate a security surveillance session on a user security portal to run an evaluation cycle during a work shift. It should be understood that the present invention is not limited to any particular period and any specified period for evaluation cycles to run is within the spirit and scope of the present invention. For example, the evaluation cycles may be ran during a time of day, shift, week, month, holiday, sports season, according to a company's work schedule, etc.

In addition, evaluation cycle parameters pane 901 includes cycle name field 904, start and end date fields 905 and 906, start and end time fields 907 and 908, days of the week fields 909, notes section 910, test feed frequency field 915, view time frequency 916, number of feed views field 917, and cycle break duration time field 918. As shown, a system administrator has indicated that for the swing shift on weekdays, the evaluation cycle will be utilized all year from 1600 to 2400. Additionally, a test feed evaluation should occur for every 200 regular live video feed evaluations. The evaluation cycle is also configured such that only one video feed is displayed within the security display window at a time. Furthermore, the system allows for a cycle break for duration of five minutes. It should be appreciated that the present invention is not limited to the selections illustrated in FIG. 9A since they are only for exemplary purposes.

FIG. 9B is an illustration of a system administrator screen 950 for setting the video camera selections when creating a new evaluation cycle. In particular, FIG. 9B illustrates video camera selection pane 902 and the video feeds of areas of interest. As shown, the video feeds displayed on video camera selection pane 902 are the following: West Entry Gate 921, North Interior Corridor 923, East Vehicle Gate 925, North Parking Lot 927, Library Courtyard 929, Loading Dock Area 931, Service Hallway 933, and Recycle Bin Area 935. As indicated by scroll bar 946, additional video camera selections may be present on the camera selection pane 902. Accordingly, video camera selection pane 902 may have any number of video that are suitable to provide adequate security around or inside an organization or area of interest.

FIG. 9B also illustrates a selection box under each camera location displayed on the video camera selection pane 902. For example, a checked selection box 922 is shown under the West Entry Gate 921, which indicates that a live video feed of the West Entry Gate 921 should be included in the evaluation cycle previously selected by the system administrator or authorized personnel. Unchecked selection box 945 is shown under the East Vehicle Gate 925, which indicates that a live video feed of the East Vehicle Gate 925 should not be included in the evaluation cycle previously selected by the system administrator or authorized personnel.

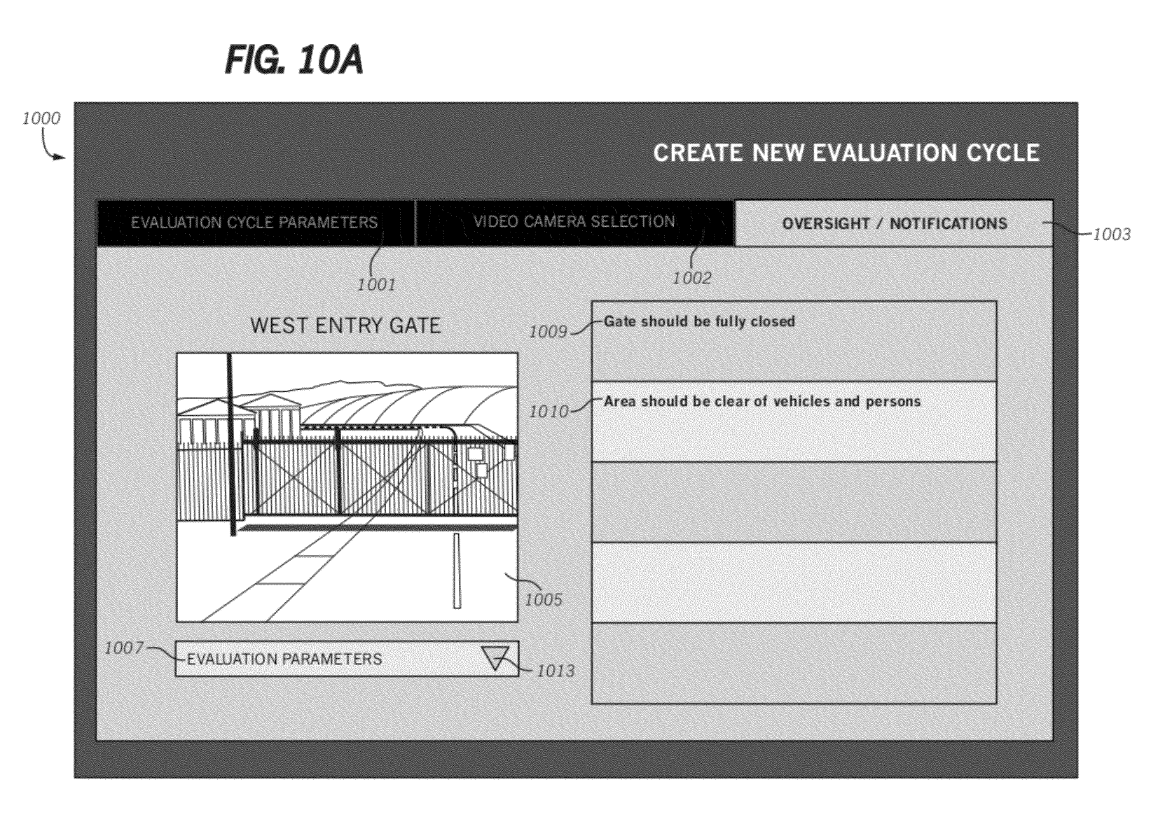

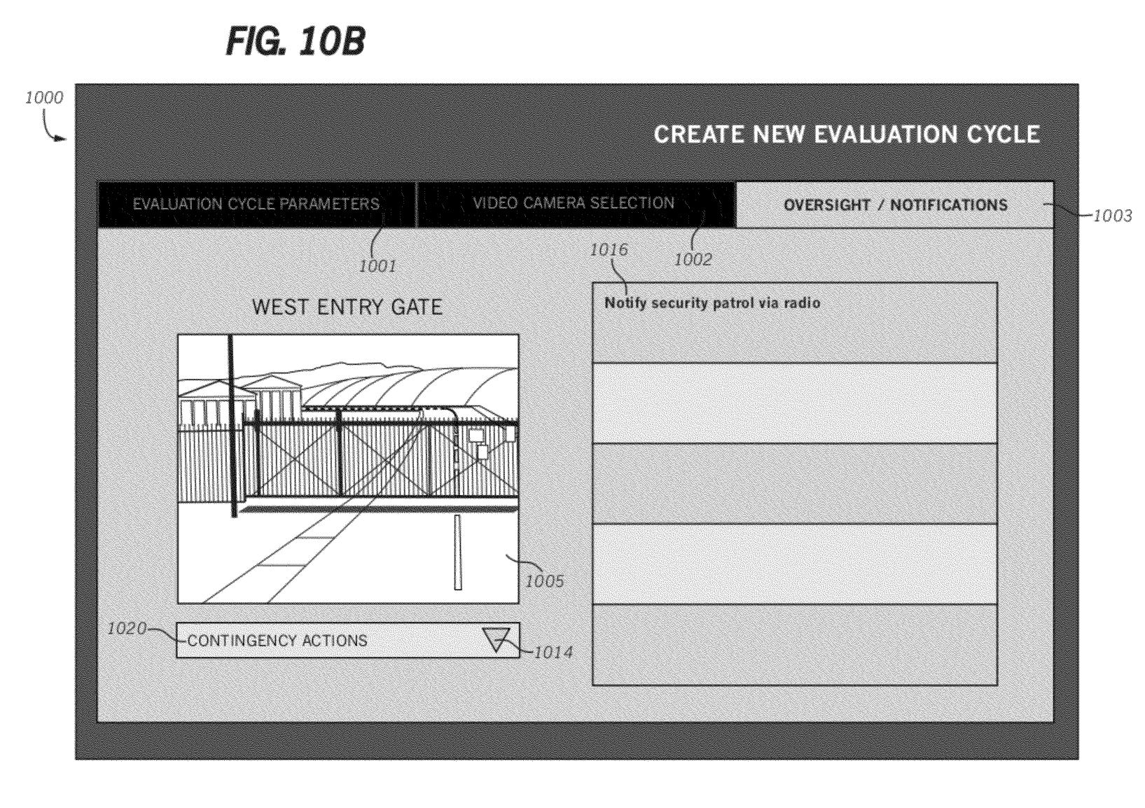

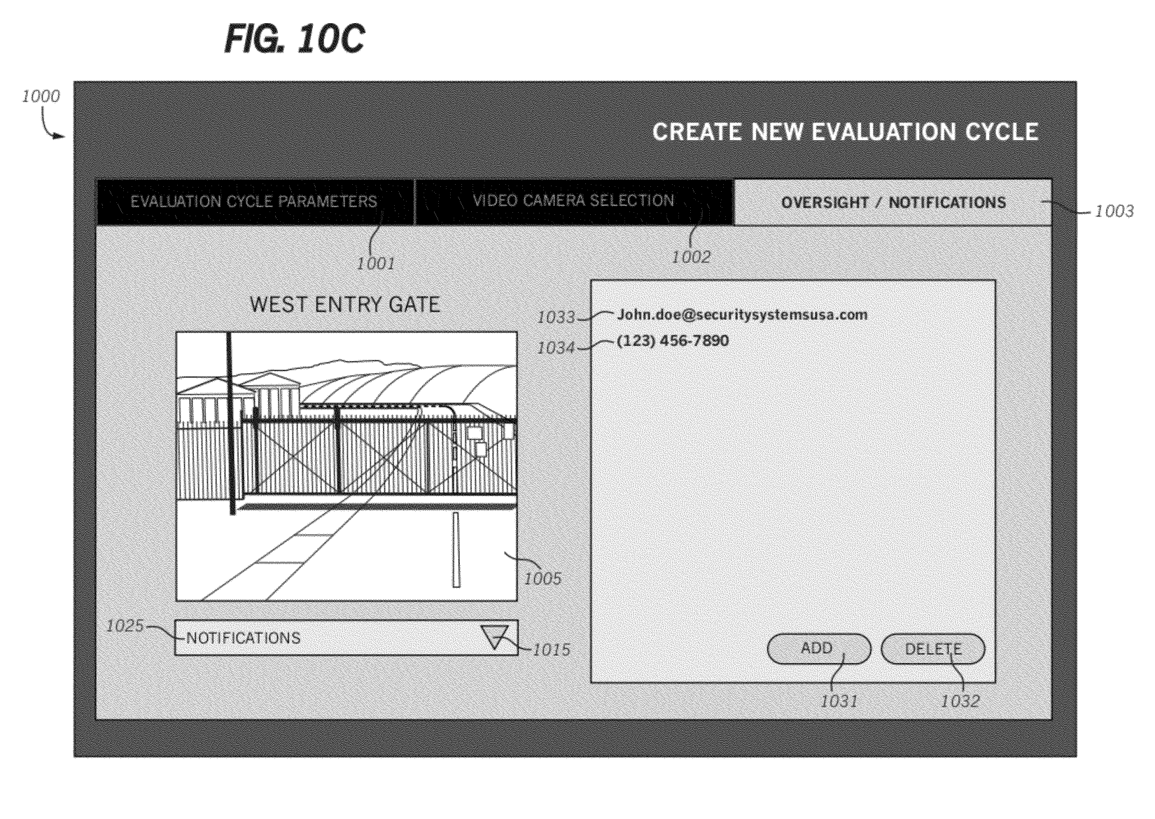

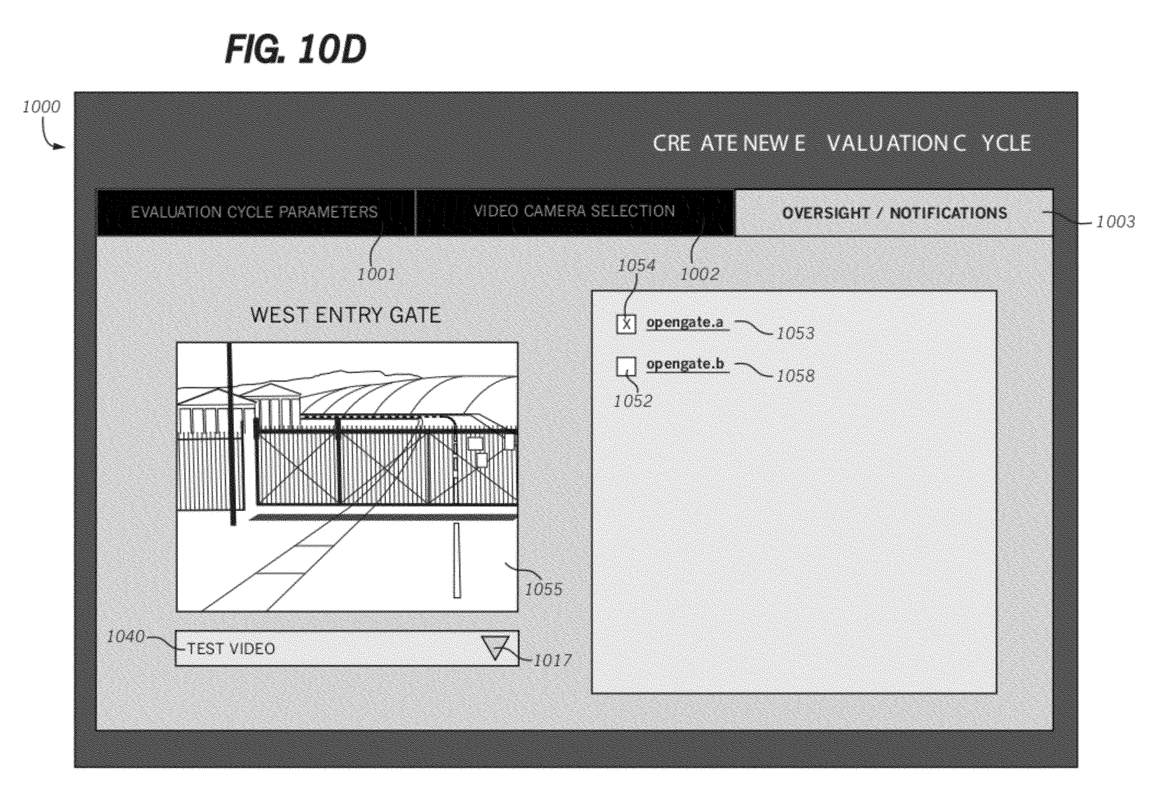

FIG. 9C is an illustration of a system administrator screen 924 for setting the oversight and notifications for an evaluation cycle. In an embodiment, a system administrator or authorized personnel may choose oversight and notifications based on the evaluation cycle and video camera selections previously selected. FIG. 9C further shows that the oversight/notification pane 903 includes oversight/notification links 981, 982, and 983. The oversight/notification links may be used to create evaluation parameters, contingency action parameters, notifications, and for selecting test feeds for each previously selected camera selection for the previously selected and configured evaluation cycle parameters. Accordingly, the aforementioned attributes may be created for the West Entry Gate, North Interior Corridor, and the Loading Dock Area. For example, FIGS. 10A-10D are illustrations of system administrator screens for the West Gate Entry, which allow authorized personnel to configure the aforementioned listed attributes.

FIG. 10A is an illustration of a system administrator screen 1000 which displays evaluation parameters for the West Entry Gate area selected for an evaluation cycle. In an embodiment, the area selected is one of the camera selections previously chosen for the evaluation cycle. Also, FIG. 10A illustrates the oversight/notifications pane 1003, in addition to a portion of the evaluation cycle parameters pane 1001 and video camera selection pane 1002.

As shown in FIG. 10A, a video feed 1005 of the West Entry Gate is displayed on the system administrator screen 1000. Authorized personnel may set up, configure, or insert evaluation parameters by first selecting the evaluation parameters tab 1007 from pull-down menu 1013. FIG. 10A further illustrates the following evaluation parameters for the West Entry Gate: gate should be fully closed (1009); and area should be clear of vehicles and persons (1010). It should be noted that authorized personnel, such as a system administrator, may configure evaluation parameters for a selected area by any means such that the authorized personnel may adequately associate the desired evaluation parameters for the selected area(s). For example, the authorized personnel may associate desired evaluation parameters for a selected area by manually entry and/or selecting from a list of pre-defined parameters.

FIG. 10B is an illustration of a system administrator screen 1000 which displays contingency action parameters 1016 for the West Entry Gate area selected for an evaluation cycle. In an embodiment, the area selected is one of the video camera selections previously chosen for the evaluation cycle. Also, FIG. 10B illustrates the oversight/notifications pane 1003, in addition to a portion of the evaluation cycle parameters pane 1001 and video camera selection pane 1002.

As shown in FIG. 10B, the video feed 1005 of the West Entry Gate is displayed upon the system administrator screen 1000. Authorized personnel may set up, configure, or insert contingency action parameters by first selecting the contingency action parameters tab 1020 from pull-down menu 1014. FIG. 10B further illustrates the contingency action parameter 1016 for the West Entry Gate—notify security patrol via radio. It should be noted that authorized personnel may configure contingency action parameters for a selected area by any means such that authorized personnel may adequately associate the desired contingency action parameters for the selected area(s). For example, authorized personnel may associate desired contingency action parameters for a selected area by manually entry and/or selecting the contingency action parameters from a list of pre-defined parameters.

FIG. 10C is an illustration of a system administrator screen 1000 which displays notification information 1033, 1034 for the West Entry Gate area selected for an evaluation cycle. In an embodiment, the selected area is one of the video camera feed selections previously chosen for the evaluation cycle. In addition, FIG. 10C illustrates the oversight/notifications pane 1003 as well as a portion of the evaluation cycle parameters pane 1001 and video camera selection pane 1002.

As illustrated in FIG. 10C, video feed 1005 of the West Entry Gate is displayed upon the system administrator screen 1000. Authorized personnel may set up, configure, or insert notification information by first selecting the notifications tab 1025 from pull-down menu 1015. Furthermore, additional notification information may be added via user selection prompt 1031 or removed by user selection prompt 1032. Examples of notification information are displayed on system administration screen 1000 as notification information 1033 and 1034. It should be noted that authorized personnel may configure notification information for a selected area by any means such that the authorized personnel may adequately associate the desired notification information for the selected area(s). For example, the authorized personnel may associate desired notification information for a selected area by manually entry and/or selecting from a list of notification information.

FIG. 10D is an illustration of a system administrator screen 1000 which displays a test video feed 1055 for an evaluation cycle. Also, FIG. 10D illustrates the oversight/notifications pane 1003, in addition to a portion of the evaluation cycle parameters pane 1001 and video camera selection pane 1002.

As shown in FIG. 10D, test feed video 1055 is displayed on the system administrator screen 1000. Authorized personnel may set up, configure, or insert test videos by first selecting the test video tab 1040 from pull-down menu 1017. FIG. 10D further illustrates the following options for displaying test feed videos: opengate.a 1053 and opengate.b 1058. As shown, authorized personnel has selected opengate.a 1053 for a test video feed as indicated by selected check box 1054. Furthermore, test video feed 1055 illustrates that West Entry Gate is open. In addition, FIG. 10D illustrates that authorized personnel has not selected opengate.b 1058, as indicated by unselected check box 1052.

It should be noted that authorized personnel, such as a system administrator, may configure test feed videos for a selected area by any means such that the authorized personnel may adequately associate the desired test feed videos for the selected area(s). For example, the authorized personnel may associate desired test feed videos for a selected area by manual entry and/or selecting from a list of pre-recorded test videos.

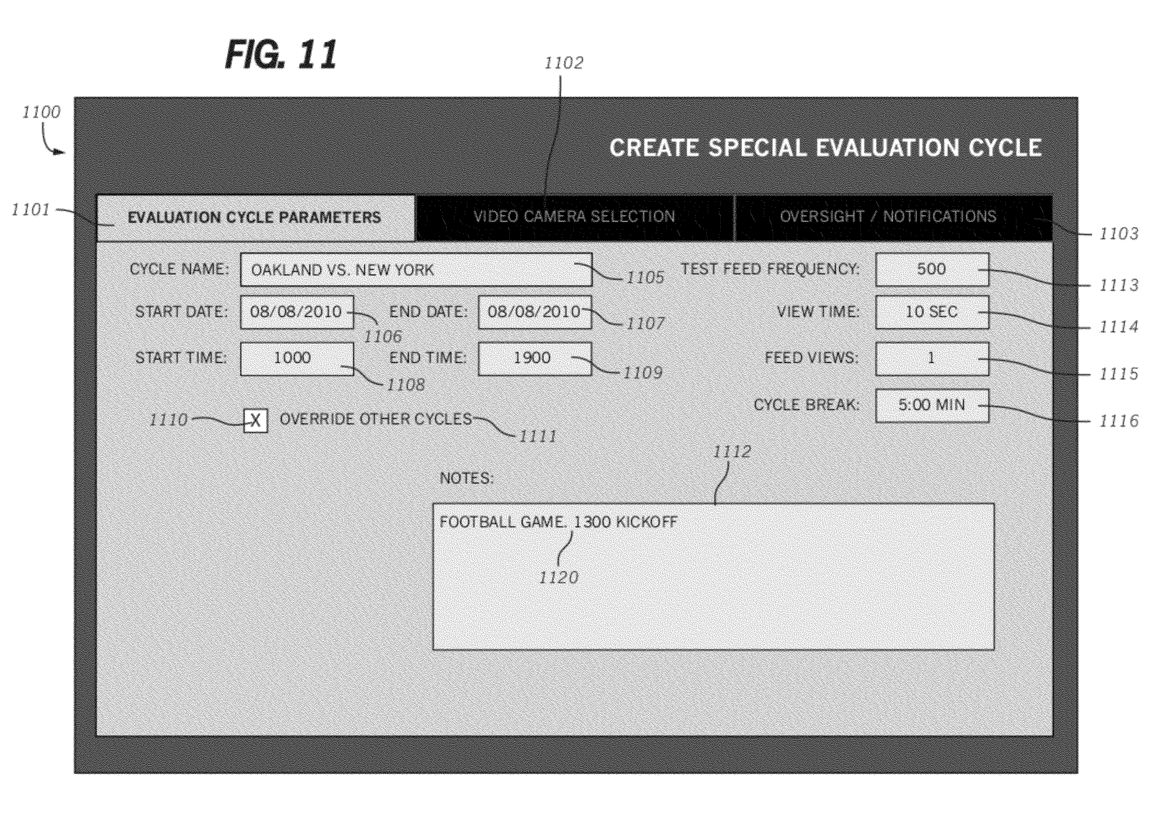

FIG. 11 is an illustration of a system administrator screen 1100 for setting evaluation cycle parameters when creating a evaluation cycle for a special event. As shown, FIG. 11 illustrates an evaluation cycle parameters pane 1101, in addition to a portion of video camera selection pane 1102 and oversight/notifications pane 1103.

As illustrated, system administrator screen 1100 includes three selectable panes—evaluation cycle parameters pane 1101, video camera selection pane 1102, and oversight/notifications pane 1103. In an embodiment, the system administrator or authorized personnel sets up or configures the evaluation cycle parameters via the evaluation cycle parameters pane 1101 prior to setting up the video camera selection and oversight/notifications parameters on each respective pane. As such, according to the embodiment, the video camera selection and oversight/notification parameters are set in relation to the evaluation cycle parameters. In yet another embodiment, a system administrator or authorized personnel may configure the video camera selection parameters prior to configuring the oversight/notification parameters.

A special evaluation cycle may be created to run during a certain period. It should be understood that the present invention is not limited to any particular period and any specified period for special evaluation cycles to run is within the spirit and scope of the present invention. For example, the evaluation cycles may be ran during a time of day, shift, week, month, holiday, sports season, according to company's work schedule, etc.

As shown, evaluation cycle parameters pane 1101 includes cycle name field 1105, start and end date fields 1106 and 1107, start and end time fields 1108 and 1109, override check box 1110, notes section 1112, test feed frequency field 1113, view time frequency 1114, number of feed views field 1115, and cycle break duration time field 1116. As shown, a system administrator or other authorized personnel has set up a special evaluation cycle for a football game (Oakland vs. New York).

In addition, the administrator screen 1100 shows that system administrator has indicated that the evaluation cycle for the special event will be utilized on Aug. 8, 2010 from 1000 to 1900. Additionally, a test feed evaluation will occur for every 500 regular live video feed evaluations. Furthermore, one video feed will be displayed within the security display window at a time and the view time for each security display window is ten seconds. In addition, override check box 1110 is selected which indicates that the special evaluation cycle will override other cycles 1111 or any scheduled evaluation cycles. Moreover, the system allows for a cycle break for duration of five minutes. Finally, the notes section 1112 includes a message 1120 that indicates that kickoff for the football game starts at 1300. It should be appreciated that the present invention is not limited to the entries illustrated in FIG. 11 since it is only for exemplary purposes.

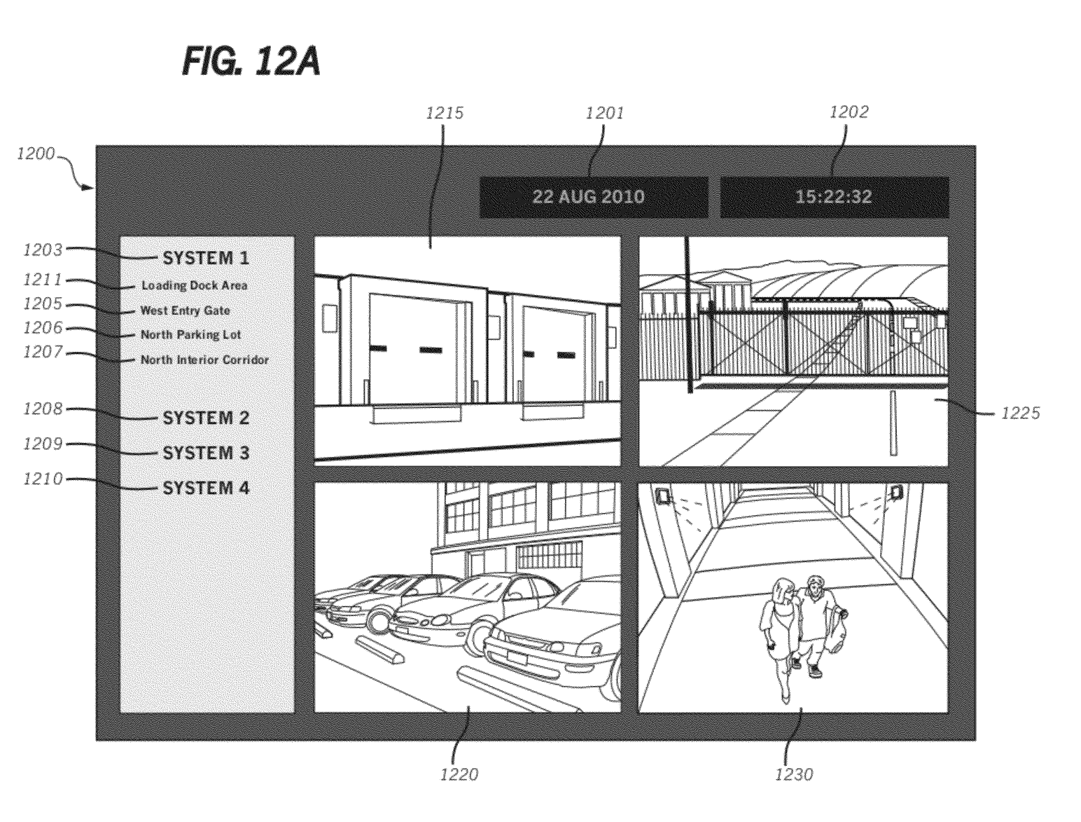

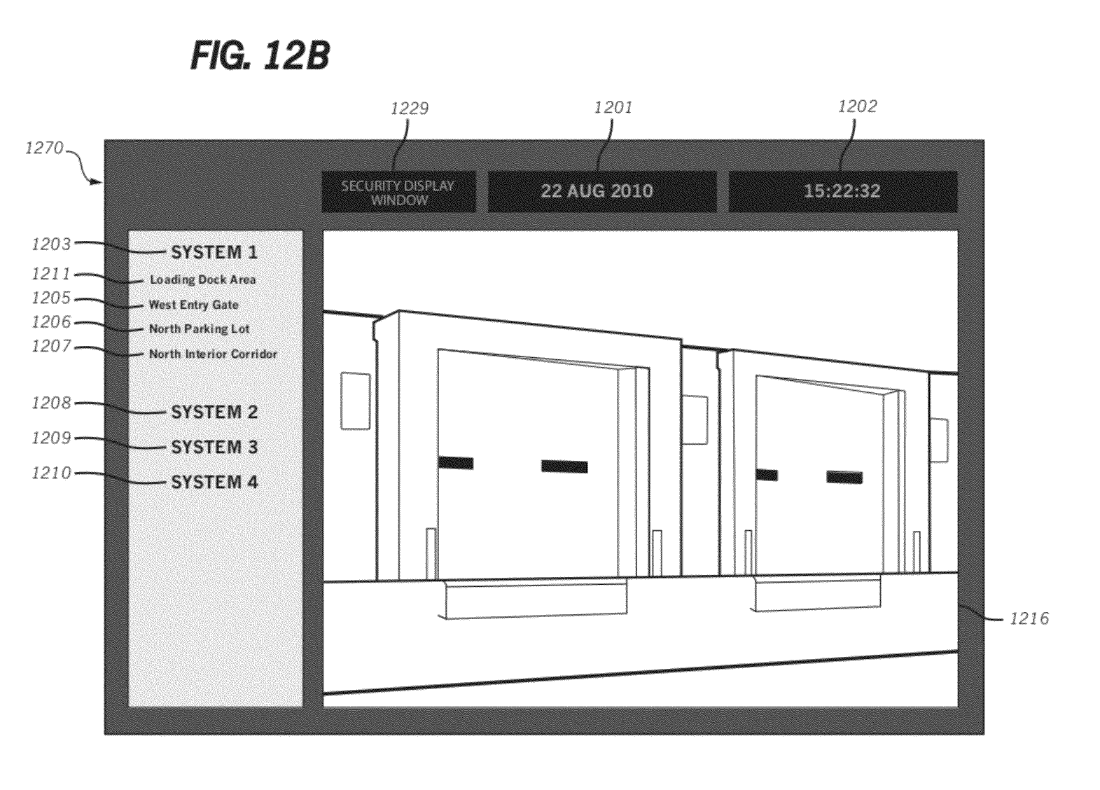

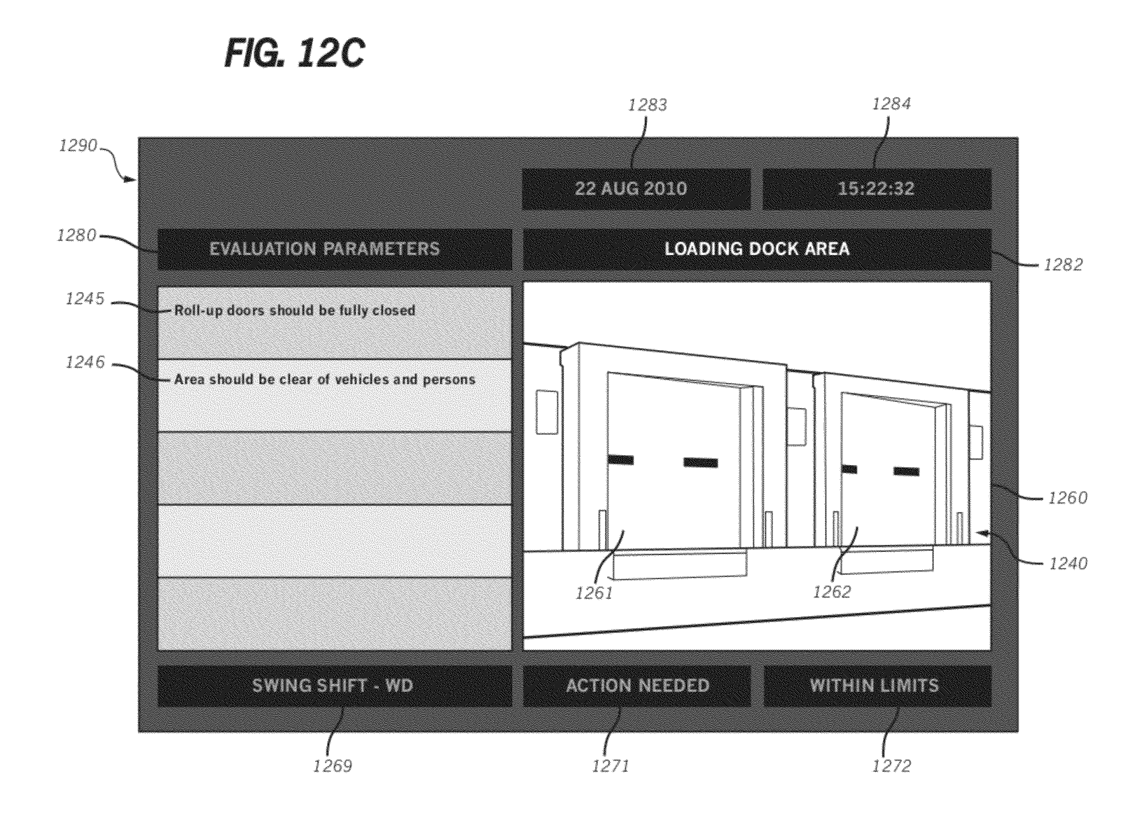

FIG. 12A is an illustration of a security display 1200 which displays multiple live video feeds 1215, 1220, 1225, and 1230. As shown, security display 1200 includes a date and time field 1201, 1202. In addition, a plurality of Systems 1203, 1208, 1209, and 1210 are shown in addition to links 1205, 1206, 1207, and 1211 of the live video feeds associated with System 1 (1203). Accordingly, a user security portal and system administrator workstation may access live video feeds without running an evaluation cycle.

FIG. 12B is an illustration of a security display 1270 which displays a selected live video feed 1216 from a plurality of video feeds (see FIG. 12A). In particular, the selected live video feed is of a Loading Dock Area. As shown, security display 1270 includes a date and time field 1201, 1202. Additionally, a plurality of systems 1203, 1208, 1209, and 1210 are shown in addition to links 1205, 1206, 1207, and 1211 of live video feeds associated with System 1 (1203). Furthermore, FIG. 12B illustrates user selection prompt 1229, which allows an user to view a security display window associated with the live video feed 1216 (see FIG. 12C).

FIG. 12C is an illustration of a security display window 1290 which displays a selected live video feed 1260 and associated evaluation parameters 1245, 1246. As shown, the security display window 1290 includes live video feed 1260, video camera location name field 1282, parameter name field 1280, evaluation parameters 1245 and 1246, user selection prompts 1271, 1272, shift field 1269, and date and time fields 1283, 1284. As described above, security personnel may evaluate the live video feed 1260 according to the evaluation parameters 1245, 1246 in addition to the security personnel's judgment, knowledge, and discretion. As shown, roll-up doors 1261 and 1262 are fully closed and the area 1240 is clear of vehicles and persons.

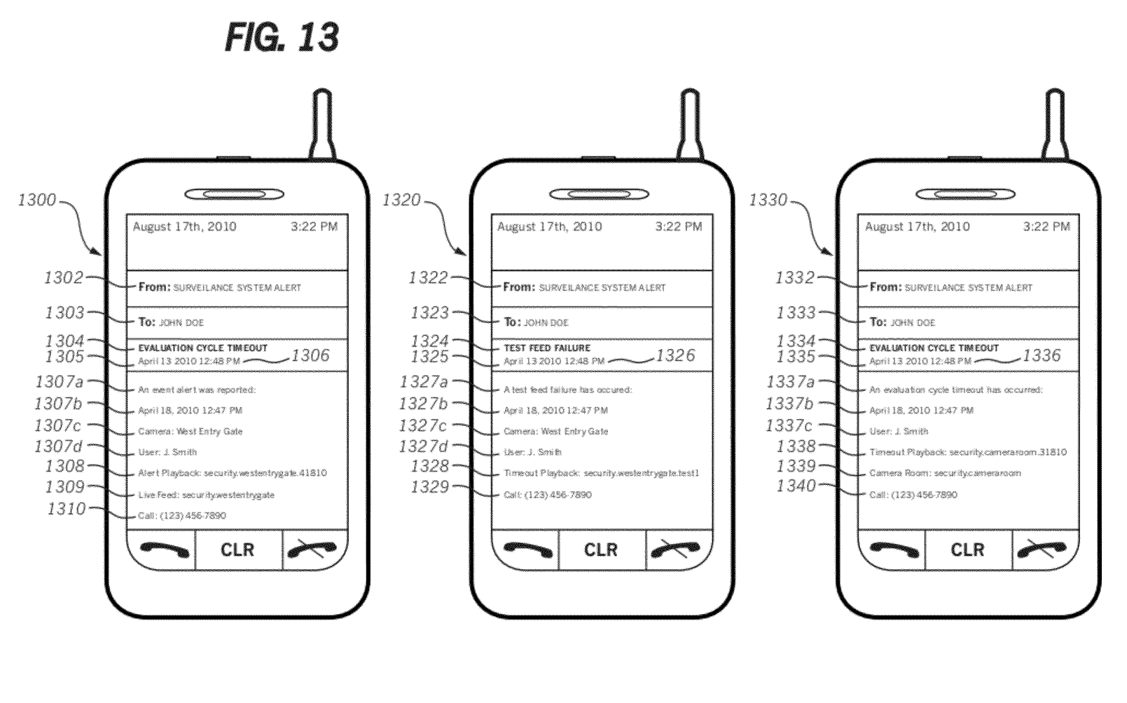

FIG. 13 includes illustrations of mobile phones 1300, 1320, 1330 to which event alerts, test feed failure alerts, evaluation cycle timeout alerts, and failure to acknowledge a start of an evaluation cycle alerts are sent. As shown, mobile phones 1300, 1320, and 1330 includes from and to fields 1302 and 1303, 1322 and 1323, and 1332 and 1333, respectively. Furthermore, phones 1300, 1320, and 1330 display subject lines 1304, 1324, and 1334, respectively, for messages that are sent to the mobile phones. In addition, the dates and times 1306, 1326, and 1336 the messages were sent are displayed on phones 1300, 1320, and 1330, respectively.

Moreover, key information about an event are displayed in a message on each mobile phone 1300, 1320, and 1330. For example, mobile phone 1300 displays information 1307a-1307d, 1308, 1309, and 1310 which collectively informs a subscribing supervisor or other authorized personnel when an event alert was reported 1307a, 1307b with respect to a specific video camera 1307c, the security personnel on duty 1307d, links to the alert playback and video feed 1308, 1309, and contact information 1310.

Similarly, mobile phones 1320 and 1330 display information 1327a-1327d, 1328, 1329, 1337a-1337c, 1338, 1339, and 1340, which collectively informs, respectively, a subscribing supervisor or other authorized personnel information regarding the test feed failure and evaluation cycle timeout alerts.

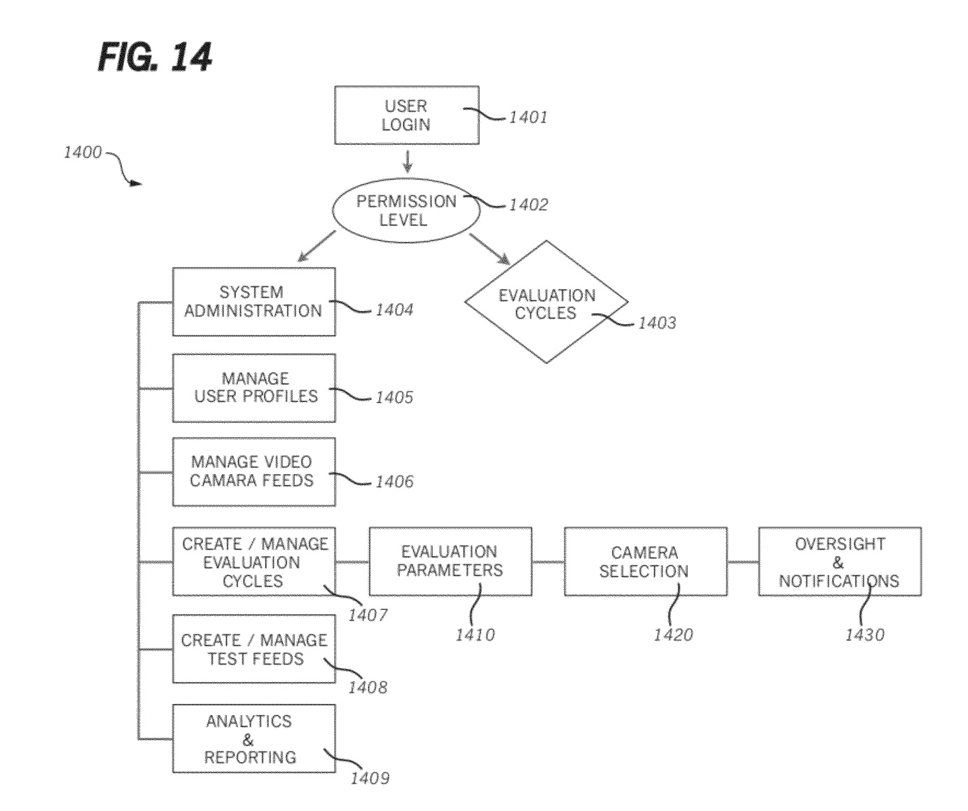

FIG. 14 is an exemplary flowchart 1400 for users of a video surveillance system in accordance with a system and method of the present invention. As shown, a user may log into a video surveillance system by activating a security surveillance session, as indicated by block 1401. According to the user's permission level 1402, the user is directed to either run an evaluation cycle 1403 or given system administrator privileges 1404. If the user is given system administrator privileges, the user may choose to manage user profiles 1405, manage video camera feeds 1406, and create/manage evaluation cycles 1407. In an embodiment, users can create/manage evaluation cycles 1407 by configuring evaluation parameters (1410), camera selections (1420), and oversight and notifications (1430). A user with system administrator privileges may create and manage test feeds (1408) as well as create and retrieve analytics and reporting (1409). In addition, users with system administrator privileges may run an evaluation cycle.

A video surveillance system has been described. It will be understood by those having ordinary skill in the art that the present invention may be embodied in other specific forms without departing from the spirit and scope of the invention disclosed. In addition, the examples and embodiments described herein are in all respects illustrative and not restrictive. Those skilled in the art of the present invention will recognize that other embodiments using the concepts described herein are also possible.

What is claimed is:

1. A system, comprising:
an user security portal operable to access at least one live video feed of at least one area taken by at least one video camera, wherein said user security portal includes:
an user interface operable to display at least one evaluation cycle, wherein said at least one evaluation cycle comprises at least one security display window, wherein each security display window displays at least one of said live video feeds, a plurality of evaluation parameters associated with said at least one area, and a plurality of contingency action parameters which lists action items to be taken in an event of a security breach of at least one of said plurality of evaluation parameters.

2. The system of claim 1, wherein security personnel responds to said security breach according to said plurality of contingency action parameters and judgment of said security personnel.

3. The system of claim 1 further comprising a first user selection prompt selectable to indicate that at least one of said plurality of evaluation parameters are violated and a second user selection prompt selectable to indicate that all of said plurality of evaluation parameters are in compliance, wherein said first user selection prompt and said second selection prompt are displayed within each security display window.

4. The system of claim 3, wherein said second user selection prompt further indicates that additional action needs to be taken although none of said plurality of evaluation parameters are violated based on said judgment of said security personnel.

5. The system of claim 1, wherein said security personnel may run the evaluation cycle by utilizing said user security portal.

6. The system of claim 1, wherein said security personnel runs said at least one evaluation cycle by activating a security surveillance session.

7. The system of claim 1, wherein said at least one video camera is a network video camera.

8. The system of claim 1, wherein said evaluation cycle displays at least one of said live video feeds for a minimum of five seconds.

9. The system of claim 1, wherein said security personnel are aided in determining whether said breach has occurred by evaluating said at least one area in view of said plurality of evaluation parameters.

10. A system, comprising:
an user security portal operable to access at least one live video feed of at least one area taken by at least one video camera, wherein said user security portal includes:
an user interface operable to display at least one evaluation cycle, wherein said at least one evaluation cycle comprises at least one security display window, wherein each security display window displays at least one of said live video feeds, a plurality of evaluation parameters associated with said at least one area, and a plurality of contingency action parameters which lists action items to be taken in an event of a security breach of at least one of said plurality of evaluation parameters, wherein security personnel utilizes judgment and at least one of said evaluation parameters to determine whether said security breach has occurred.

11. The system of claim 10, wherein said security personnel responds to said breach according to at least one of said plurality of contingency action parameters and judgment, knowledge, and discretion of said security personnel.

12. A system, comprising:
a system administrator workstation operable to allow an user to perform any of managing user profiles, managing at least one video camera feed, creating and managing at least one evaluation cycle by configuring at least one evaluation parameter, at least one video camera selection, and at least one notification information, wherein said at least one evaluation cycle includes:
at least one security display window, wherein each security display window displays at least one of said live video feed of said at least one area, said at least one evaluation parameter associated with said at least one area, and at least one contingency action parameter which lists action items to be taken in an event of a security breach of said at least one evaluation parameter, wherein security personnel responds to said security breach according to said at least one contingency action parameter and judgment of said security personnel.

13. The system of claim 12, wherein said security personnel utilizes any of judgment, knowledge, discretion, and at least one of said evaluation parameters to determine whether said breach has occurred.

14. The system of claim 12, wherein said at least one contingency action parameter is any of notifying security patrol; describing persons, activity and direction of travel; continuing to monitor and update responding security personnel; and calling emergency help if necessary.

15. A method, comprising:
operating an user security portal operable to access at least one live video feed of at least one area taken by at least one video camera, wherein said user security portal includes:
operating an user interface to display at least one evaluation cycle, wherein said at least one evaluation cycle includes at least one security display window, wherein each security display window displays at least one of said live video feeds of said at least one area, a plurality of evaluation parameters associated with said at least one area, and a plurality of contingency action parameters which recommend action items to be taken in an event of a security breach of at least one of said plurality of evaluation parameters, wherein security personnel responds to said security breach according to said plurality of contingency action parameters and judgment of said security personnel.

16. The method of claim 15, wherein operating said user security portal includes requiring a user to log in.

17. The method of claim 15, wherein said user security portal has a plurality of permission levels.

18. A method, comprising:
performing an evaluation test during an evaluation cycle, wherein performing said evaluation test includes:
displaying a test video feed during said evaluation cycle, wherein security personnel are able to indicate whether said test video feed is in compliance with security protocol according to at least one evaluation parameter and judgment of said security personnel.

19. The method of claim 18, wherein an error message is issued in an event that said security personnel fails to correctly address said test video feed according to a default setting of said evaluation cycle.

20. The method of claim 18, wherein said test video feed is displayed before and after a live video feed.
